(19) United States
(12) Patent Application Publication
(10) Pub. No.: US 2007/0016549 A1
(43) Pub. Date: Jan. 18, 2007

(54) Method system, and digital media for controlling how digital assets are to be presented in a playback device

(75) Inventor: Timothy J. Whitcher, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/183,465

(22) Filed: Jul. 18, 2005

(51) Int. Cl. G06F 17/30; G06F 7/00; G06F 17/00; G06F 3/00

(52) U.S. Cl. 707/1; 707/100; 715/700; 715/500.1

(57) ABSTRACT

A system, software program and method for playing a digital media presentation present on a storage media on a playback device wherein the storage media having a descriptor file that describes a digital media presentation. The descriptor file having an asset location table which includes information regarding at least one remote digital media file that is to be played in the presentation, the information is used by the playback device so that the at least one remote digital asset can be located and properly sequenced in the presentation.

### FIELD OF THE INVENTION

The present invention relates to controlling how digital assets are to be presented in a playback device.

### BACKGROUND OF THE INVENTION

Digital media assets are stored in a variety of forms for example on DVD, CD, memory cards, memory sticks, etc. In many instances these digital assets are designed to be presented in a particular designated presentation. Metadata is increasingly used for controlling how digital assets are presented in a playback device. For example, metadata is used in Music Photo Video (MPV) which uses XML-based descriptors to describe how various digital assets such as digital images, audio files, and video files are to be collectively presented to a user in the form of a slide show. The use of manifests to describe presentations has a shortcoming in that a consistent playback experience cannot be guaranteed, particularly if any one of the digital assets of the presentation is remote from the storage device.

In manifests used in MPV technology, the location of the digital assets to be presented is described by what is known as the Last URL XML element. The last known location can be a local file name or a remote URL. Zero or more <mpv:LastURL> elements may be specified for a particular digital asset allowing for multiple methods to locate a particular digital asset. The recommended use of all Last URL elements is to select them through the proper file system by the <mpv:filesystem> attribute. Normally, the same <mpv:filesystem> attribute is used only once.

An additional problem occurs when the Last URL is used for preparing the presentation because the Last URL is based on any URI type. (Uniform Resource Identifiers). The Last URL may reference a digital asset on the same store as the location of the manifest itself, or the digital asset may be on a different store, or the digital asset may be located by network access. Consequently, the time needed to access or retrieve the asset varies considerably. This results in potential variation in the playback experience when multiple digital assets are provided, particularly when located remotely.

While attempts have been made to avoid the above problems by providing a “show rendition” of the entire slide show, this prior art approach generally involves transcoding, which requires time and resources by the originating system and consumes space on the store.

The present invention is directed to an efficient way of solving the foregoing problems of the prior art by providing a method, system, and digital storage media in a format that provides a seamless uninterrupted presentation to the user.

### SUMMARY OF THE INVENTION

In accordance with one aspect of the present invention there is provided a method for playing a digital media presentation present on a storage media on a playback device, the storage media having a descriptor file that describes a digital media presentation, the descriptor file having an asset location table which includes information regarding at least one remote digital media file that is to be played in the presentation, the information is used by the playback device so that the at least one remote digital asset can be located and properly sequenced in the presentation, comprising the steps of:

the playback device reading the descriptor file so as to obtain the information associated with the at least one remote digital asset;

retrieving the at least one remote digital asset using the information; and

coordinating the playing of the at least one remote digital asset with the digital media presentation using the information.

In accordance with another aspect of the present invention there is provided a method for creating a digital playback media having a digital media presentation to be played on a playback device, comprising the steps of:

defining a digital presentation having at least one remote digital asset; and

writing a descriptor file on a digital play back media that defines a digital presentation, the descriptor file containing an asset locatable table providing information with respect to at least one remotely located digital media to be played in the digital presentation, the information is used by the playback device so that the at least one remote digital asset can be located and properly sequenced in the presentation.

In accordance with yet another aspect of the present invention there is provided a computer software program such that when programmed in a computer of a playback device for playing a digital media presentation provided on a storage media allows the playback device to perform the steps of:

reading a descriptor file on the storage media that describes a digital media presentation, the descriptor file having an asset location table which includes information regarding at least one remote digital media file that is to be played in the presentation;

retrieving the at least one remote digital asset using the information; and

coordinating the sequential playing of the at least one remote digital asset in the digital media presentation using the information.

In accordance with still another aspect of the present invention there is provided a computer software program such that when programmed in a computer of a device for creating a digital media presentation provided on a storage media allows the device to perform the steps of:

defining a digital presentation having at least one remote digital asset; and

writing a descriptor file on the storage media that describes the digital media presentation, the descriptor file having an asset location table which includes information regarding the at least one remote digital media file that is to be played in the presentation.

In accordance with another aspect of the present invention there is provided a digital media storage device having a digital media presentation digitally recorded thereon, the digital media presentation comprising:

a descriptor file that describes the digital media presentation, the descriptor file having an asset location table which includes information regarding at least one remote digital media file that is to be played in the presentation, the information is used by a playback device so that the at least one remote digital asset can be located and properly sequenced in the presentation.

In accordance with yet still another aspect of the present invention there is provided a system for creating and/or playing a digital presentation providing a digital storage media comprising:

a creating device for creating a digital media presentation provided on a storage media, the creating device having a digital presentation generating unit for the media presentation having at least one remote digital asset and a descriptor file on the storage media that describes the digital media presentation, the descriptor file having an asset location table which includes information regarding the at least one remote digital media file that is to be played in the presentation;

a playback device for reading the descriptor file on the storage media for retrieving the at least one remote digital asset using the information, and for coordinating the sequential playing of the at least one remote digital asset in the digital media presentation using the information.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is a system diagram for authoring removable storage media having presentations in accordance with the present invention;

FIG. 2 is a flow diagram illustrating the creation of a digital media format in accordance with the present invention;

FIGS. 3a, 3b & 3c illustrate various forms of an album play manifest file provided on a media made in accordance with the present invention; and

FIG. 4 is a flow diagram for playing a presentation on a digital media made in accordance with the present invention.

### DETAILED DESCRIPTION OF THE INVENTION

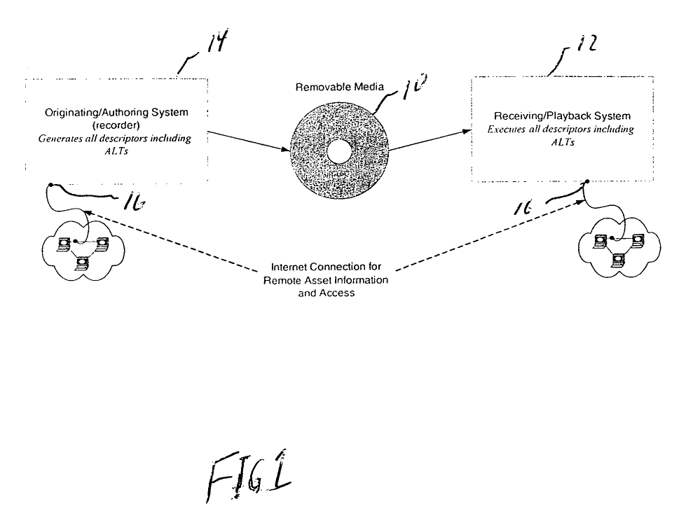

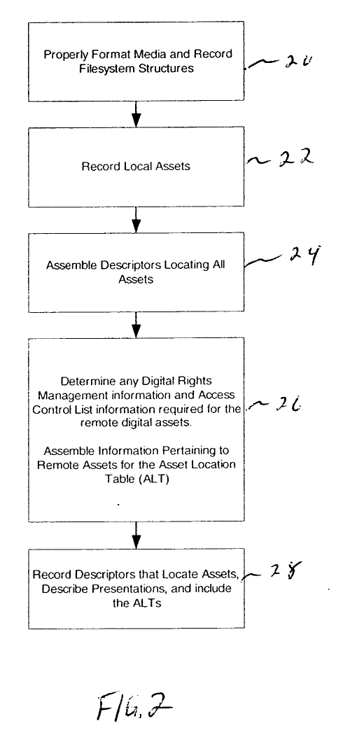

Referring to FIG. 1, there is illustrated a diagram for producing and playing back a digital media storage device 10 made in accordance with the present invention. In the particular embodiment illustrated, the digital media storage devices comprises a removable CD. However the digital media storage device 10 may comprise any other device that supports a file system upon which digital media assets may be recorded or stored. For example, but not limited to, DVD, memory card, memory stick, etc. The digital assets stored on the digital media storage device 10 may comprise any type of digital assets, for example but not limited to, still images, audio files, and video files. These digital assets may be presented to the user through an appropriate playback device 12 in a designated presentation. The designated presentation may be generated in any desired manner by any appropriate entity. The digital media provided on storage device 10 may be created by any appropriate recording device 14 appropriate for providing and storing digital assets on the digital media storage device 10. The creating/recording device 14 and playback device 12 may each have the capability of accessing other devices at other locations where digital media assets are stored through a communication connection 16 over a communication network, such as the internet.

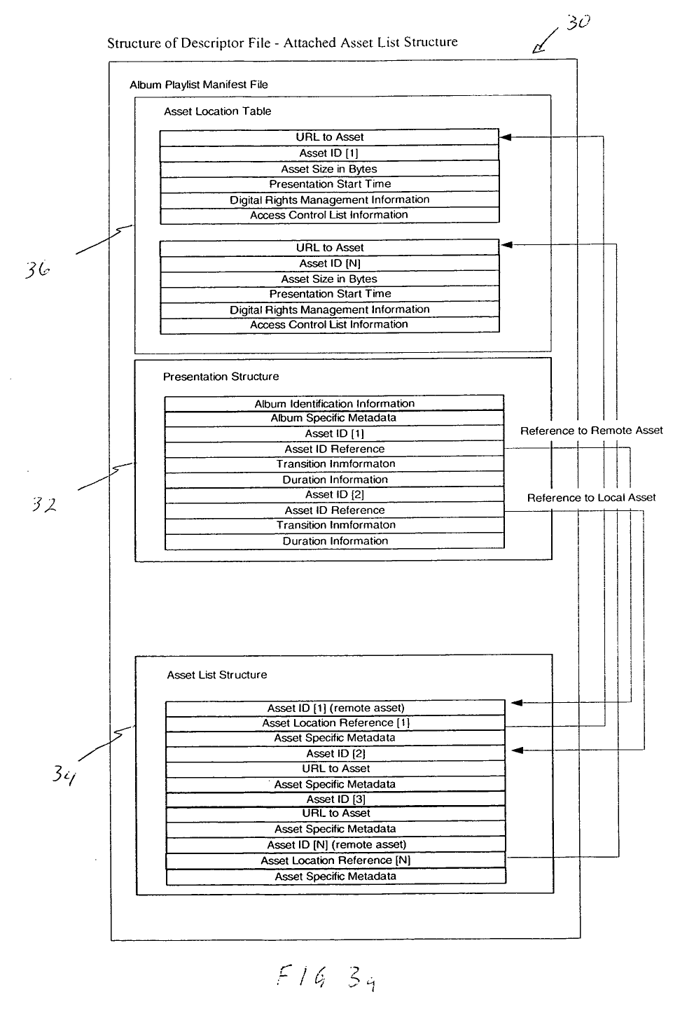

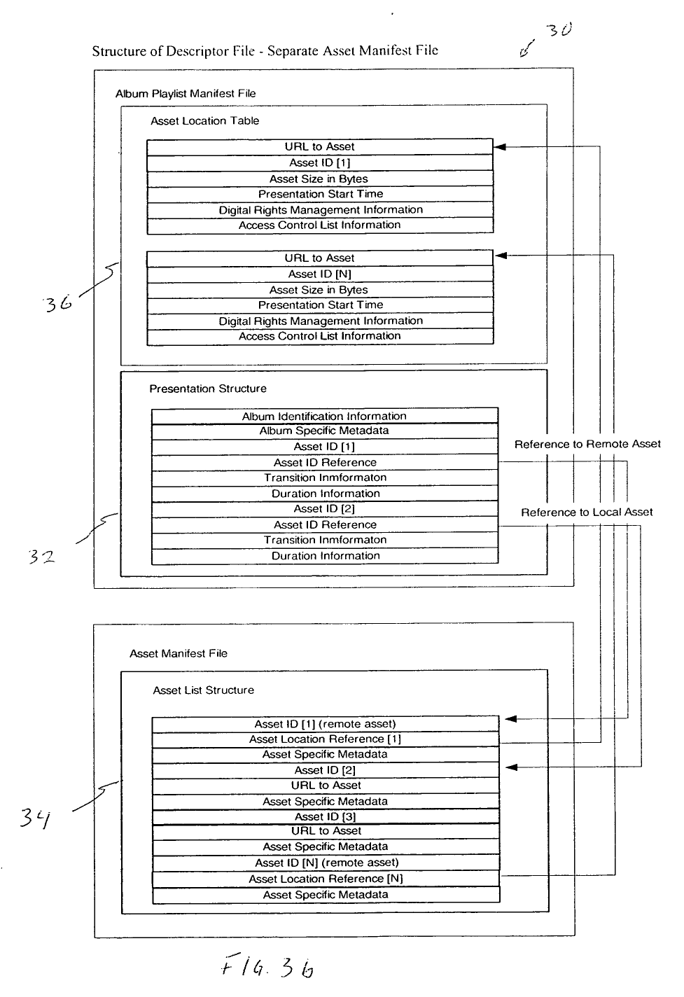

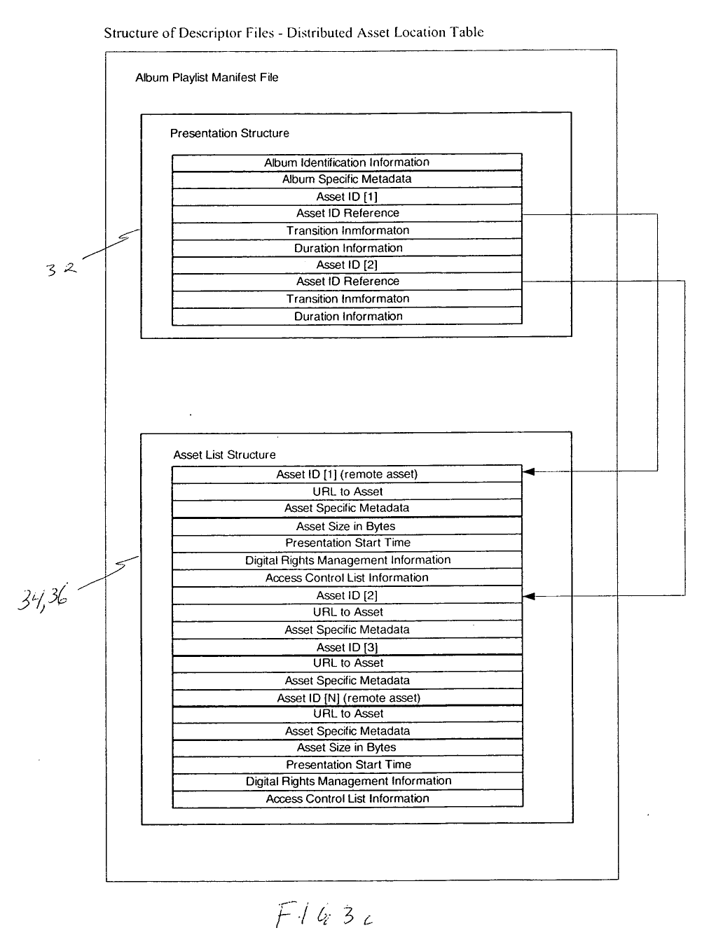

Referring to FIG. 2, there is illustrated the steps in creating a presentation on digital media storage device 10 by recording device 14. After the digital media is properly placed in the recording device 14, the recording device 14 at step 20 properly formats the digital media storage device 10 and records the file system structures that includes an album playlist manifest file 30 (as shown in FIG. 3 and later described herein) for properly playing back the digital assets either identified or recorded the digital recording medium 10. At step 22 the recording device records the local digital assets onto the digital media storage device 10 Then the recording device 14 assembles at step 24 all the descriptors, allocating all of the digital media assets to be presented in the presentation to be played back from the digital media storage device 10. The presentation of digital assets may include any appropriate digital assets and in any particular format capable of being provided and played back by the recording and/or playback devices 12, 14. In the particular embodiment illustrated, at least one of the digital assets comprises a remote digital asset that is located remote from the digital media storage device 10 and that can be accessed remotely over a communication network as appropriate. Then, optionally, at step 26, as shown in the illustrated embodiment, there is determined whether there are any digital rights management information and access control list information required for any remote digital asset that is to be presented in the presentation. Also at step 26 the information regarding the remote assets for album playlist manifest 30 is assembled. Once the information has been assembled, next at step 30, the digital asset descriptors that describe the presentation and locate the remote assets, including the album playlist manifest 30 are recorded on the digital asset media 10.

Referring to FIG. 3a there is illustrated an album playlist manifest 30 made in accordance with the present invention. As can be seen, the album playlist manifest 30 includes a Presentation Structure 32 (PS), an Asset List Structure 34 (ALS) and an Asset Location Table 36 (ALT). Presentation Structure 32 sets forth the digital assets to be provided in the presentation, the duration of each, the order in which they are to be presented, and any other appropriate information needed for proper presentation of the digital assets. The Asset List Structure 34 identifies the location of the digital asset on the digital media storage device 10 or the remote location if it is remotely located from the digital media storage device 10. The Asset Location Table 36 provides information regarding the start time with respect to the presentation, size of the asset, digital rights management associated with the asset and access control list information. When an Originating/Authoring System 14 creates a presentation that includes a remote digital asset, certain additional information might need to be presented to the remote site that contains the digital asset before that site will deliver that digital asset to a Receiving/Playback System 12. Digital Rights Management (DRM) information might need to be presented. DRM information informs the remote site that the requestor (the Receiving/Playback System 12) is authorized to receive the digital asset. Additionally, DRM network transactions will transfer any attribution information that needs to be displayed by the Receiving/Playback System 12. The Access Control List (ACL) information might also be used. The ACL information is used by the Receiving/Playback System 12 to determine if the remote asset can be viewed by the current user of the Receiving/Playback System 12. Normally ACL information would be handled at the Album Playlist level, however, network access enables the remote digital asset to have time varying content that is not known apriori and therefore cannot be recorded on the storage media. ACL information allows remote assets to be viewed only by certain users of the Receiving/Playback System 12. Normally DRM information would not be concerned with this level of filtering.

The ALT 36 is a distinct structure, which could also be XML encoded. The primary purpose of the ALT 36 is to identify those digital assets that are not local to the playback device so that they can be queued before they are needed to prevent unplanned pauses in the playback presentation. In the present invention, the ALT 36 is an embedded structure in an album play list manifest 30. Each remote digital asset that is listed in the ALT 30 will have, in addition to its last URL, information regarding the remote asset size in bytes (not pixels), and the time offset in the designated presentation.

The ALT in the present invention is provided at the beginning of the album play list manifest 30 that enables more efficient processing of the digital assets. If, as in the prior art, the information for each remote asset is bound to the reference of the remote list in the album playlist manifest, then the queuing of remote assets would not be efficient because it's not guaranteed that a given playback device will scan the entire data set described by the manifest at once. By providing the ALT 30 at the beginning of the album playlist manifest 30, it assures that the identification of all the digital assets to be provided as a part of the presentation is identified first.

A feature of the asset location table 36 is that it contains time-based information that indicates the start time for each asset to be presented by an offset from the start time of the album presentation. This is in addition to the prior art, for example, in MPV presentations a presentation profile addresses the duration that each asset may be displayed. Audio and video assets with MPV real time is assumed. MPV asynchronously fetches assets to be displayed and the playback device coordinates their presentation. Sequential playback is implied in an MPV presentation, whereas in the present invention, time-based information enables the playback device to efficiently manage the queuing of remote assets in the appropriate time for presentation. The playback device 12 may also take into consideration whether the access to the remote digital asset is over broadband communication network or a slower communication network.

In the embodiment illustrated in FIG. 3a, the ALT 36 is provided in a single descriptor file, that is in the Album Playlist Manifest File, however, the present invention is not limited to such. As illustrated in FIG. 3b the ALT is in the same descriptor files as the Presentation Structure while the Asset List File is in a separate descriptor file. In the embodiment illustrated in FIG. 3c, the ALT 36 is combined with the ALS 34. How the information recorded will be a function of the originating system, which in turn will determine how the information is accessed. What is important in the present invention is that the ALT is read first such that the appropriate remote assets can be obtained in a timely manner for proper queuing of the digital assets in accordance with the designated presentation. The Album Playlist Manifest File is first selected by the Receiving/Playback System 12. The entire playtime of the album needs to be calculated. This is done by processing all the duration information. The actual presentation begins after all remote assets are loaded. The ALT provides the information to begin the fetching of remote assets. Placing the ALT in the beginning of the Album Manifest allows preprocessing the manifest for remote digital assets, but the actual album presentation is not started until the presentation structure is processed.

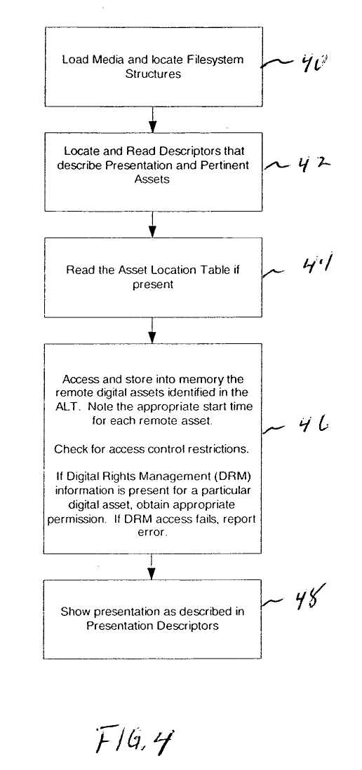

Referring to FIG. 4, there is illustrated the operation of the playback device 12. The first step 40 of the playback device would be to load the digital storage device 10 and locate the file system structure. At step 42 the playback device 12 locates and reads the descriptors that describe the presentation and pertinent digital assets. At step 44 the asset location table 36 is read first if present. Then at step 46 the playback device 12 collects and stores into memory any remote digital assets identified in the ALT 36. The playback device 12 also notes the appropriate start time for each digitally remote asset identified in the ALT 36. In addition, the playback device 12 checks for access control restrictions and digital rights management. If present, the playback device 12 obtains the appropriate permission for allowing presentation of the remote digital asset by the current user of the playback system. If the digital rights management fails, an error report is provided by the playback device 12 to the user of the playback device. Once having all the appropriate information at step 48, the playback device plays the presentation as set forth, including any digital remote assets.

Thus it can be seen that in accordance with the present invention, there is provided a method and system for efficiently presenting a presentation of digital assets on a digital media storage device 10 which includes at least one digital remote asset in a manner that provides a seamless presentation to the user of the playback device.

It is to be understood that various changes and modifications may be made without departing from the scope of the present invention. The present invention being limited by the following claims:

### PARTS LIST

10 digital media storage device
12 playback device
14 creating/recording device
16 Internet connection
20 step
22 step
24 step
26 step
28 step
30 album playlist manifest
32 presentation structure
34 asset list structure
40 step
42 step
44 step
46 step
48 step

1. A method for playing a digital media presentation present on a storage media on a playback device, said storage media having a descriptor file that describes a digital media presentation, said descriptor file having an asset location table which includes information regarding at least one remote digital media file that is to be played in said presentation, said information is used by said playback device so that said at least one remote digital asset can be located and properly sequenced in said presentation, comprising the steps of:
said playback device reading said descriptor file so as to obtain said information associated with said at least one remote digital asset;
retrieving said at least one remote digital asset using said information; and
coordinating the playing of said at least one remote digital asset with said digital media presentation using said information.

2. The method according to claim 1 wherein said asset location table is located at the beginning of the descriptor file that describes a digital media presentation.

3. The method according to claim 1 wherein said asset location table information is distributed within the descriptor file that describes a digital media presentation.

4. The method according to claim 1 wherein said information includes the location, size and start time of said remote digital asset.

5. The method according to claim 1 wherein said information also includes digital rights management information.

6. The method according to claim 1 wherein said information also includes an access control list.

7. The method according to claim 1 wherein said information also includes digital rights management information and an access control list.

8. A method for creating a digital playback media having a digital media presentation to be played on a playback device, comprising the steps of:
defining a digital presentation having at least one remote digital asset; and
writing a descriptor file on a digital play back media that defines a digital presentation, said descriptor file containing an asset locatable table providing information with respect to at least one remotely located digital media to be played in said digital presentation, said information is used by said playback device so that said at least one remote digital asset can be located and properly sequenced in said presentation.

9. The method according to claim 8 wherein said asset location table is located at the beginning of the descriptor file.

10. The method according to claim 8 wherein said asset location table information is distributed within the descriptor file that describes a digital media presentation.

11. The method according to claim 8 wherein said information includes the location, size and start time of said at least one remotely located digital asset.

12. The method according to claim 8 wherein said information also includes digital rights management information.

13. The method according to claim 8 wherein said information also includes an access control list.

14. The method according to claim 8 wherein said information also includes digital rights management information and an access control list.

15. A computer software program such that when programmed in a computer of a playback device for playing a digital media presentation provided on a storage media allows said playback device to perform the steps of:
reading a descriptor file on said storage media that describes a digital media presentation, said descriptor file having an asset location table which includes information regarding at least one remote digital media file that is to be played in said presentation;
retrieving said at least one remote digital asset using said information; and
coordinating the sequential playing of said at least one remote digital asset in said digital media presentation using said information.

16. The method according to claim 15 wherein said remote digital asset is retrieved and stored in a memory of said playback device prior to when said digital asset is needed in said presentation

17. A computer software program such that when programmed in a computer of a device for creating a digital media presentation provided on a storage media allows said device to perform the steps of:
defining a digital presentation having at least one remote digital asset; and
writing a descriptor file on said storage media that describes said digital media presentation, said descriptor file having an asset location table which includes information regarding said at least one remote digital media file that is to be played in said presentation.

18. A digital media storage device having a digital media presentation digitally recorded thereon, said digital media presentation comprising:
a descriptor file that describes said digital media presentation, said descriptor file having an asset location table which includes information regarding at least one remote digital media file that is to be played in said presentation, said information is used by a playback device so that said at least one remote digital asset can be located and properly sequenced in said presentation.

19. A digital media storage device according to claim 18 wherein said digital media storage device comprises any one of the following:
CD,
DVD,
IPOD,
memory card.

20. A digital media storage device according to claim 18 wherein said digital media presentation comprising any one or combination of the following:
digital images,
digital videos,
audio files.

21. A digital media storage device according to claim 18 wherein said digital media presentation comprises a slide presentation having any one or combination of the following:
digital images,
digital videos,
audio files.

22. A system for creating and/or playing a digital presentation providing a digital storage media comprising:
a creating device for creating a digital media presentation provided on a storage media, said creating device having a digital presentation generating unit for said media presentation having at least one remote digital asset and a descriptor file on said storage media that describes said digital media presentation, said descriptor file having an asset location table which includes information regarding said at least one remote digital media file that is to be played in said presentation;
a playback device for reading said descriptor file on said storage media for retrieving said at least one remote digital asset using said information, and for coordinating the sequential playing of said at least one remote digital asset in said digital media presentation using said information.
